(19) United States
(12) Patent Application Publication
(10) Pub. No.: US 2009/0097379 A1
(43) Pub. Date: Apr. 16, 2009

(54) HOLOGRAM DEVICE

(75) Inventor: Yoshihiro Someno, Miyagi-ken (JP)

Correspondence Address: BRINKS HOFER GILSON & LIONE, P.O. BOX 10395, CHICAGO, IL, 60610, US

(73) Assignee: Alps Electric Co., Ltd., Tokyo (JP)

(21) Appl. No.: 12/332,034

(22) Filed: Dec. 10, 2008

(30) Foreign Application Priority Data
Jun. 15, 2006 (JP) 2006-166401
Jun. 12, 2007 (JP) PCT/JP2007/061769

(51) Int. Cl. G11B 7/00

(52) U.S. Cl. 369/103; G9B/7

(57) ABSTRACT

In a hologram device, a reflecting mirror is provided on a light path of reproduction light, the reproduction light is oriented in a direction parallel to an optical recording medium, and, then, a light-receiving member receives the light. Since the light-receiving member need not be provided in a thickness direction, even if a light path length is increased, the hologram device can be made thin. In addition, by using the reflecting mirror having a very small area, it is possible to restrict crosstalk even without a pinhole. Further, a light-receiving device is accommodated in a housing, and the reproduction light is incident upon the interior of the housing through a transparent cover, so that it is possible to prevent entry of dust.

### RELATED APPLICATIONS

This application claims benefit of the Japanese Patent Application No. 2006-166401 filed on Jun. 15, 2006, which is hereby incorporated by reference.

### BACKGROUND

1. Field of the Invention

The present invention relates to a hologram device that reads out a hologram recorded on an optical recording medium by multiplexing. More particularly, the present invention relates to a hologram device that can reduce crosstalk without a pinhole, and that is suitable for being made thin.

2. Description of the Related Art

A hologram device requires a technology that reduces what is called crosstalk by only obtaining reproduction light from a predetermined hologram and blocking reproduction light from other holograms during reproduction.

In Japanese Unexamined Patent Application Publication No. 2006-58726, as such a technology, a hologram device including a pinhole filter is discussed.

However, in the hologram device including a pinhole filter, a numerical aperture NA of a lens during recording needs to be the same as that during reproduction. Storage capacity of holograms per page depends upon a numerical aperture NA of a lens during writing. Therefore, when the storage capacity of holograms per page is increased by using a lens having a large numerical aperture NA during writing, a lens having a large numerical aperture NA is also required during reproduction.

However, since a lens having a large numerical aperture NA has a large spherical aberration, a high-precision aspherical lens is required. However, it is difficult to make such a lens compact.

In addition, since a lens having a large numerical aperture NA has a short focal length, the distance between an optical recording medium and a pinhole opposing the optical recording medium tends to be short. For example, hitherto, the distance between a pinhole and an optical recording medium has been small at approximately 100 μm. Therefore, when static electricity is generated between the pinhole and the optical recording medium, dust tends to accumulate therebetween. At worst, the dust may fill up the pinhole.

Further, if the optical recording medium is deformed by, for example, being warped, when a pickup having a light-receiving member mounted thereto is moved, the pinhole may collide with the optical recording medium, as a result of which the pinhole or the optical recording medium may be scratched or deformed.

In contrast, since a lens having a small numerical aperture NA has a longer focal length, the pickup becomes large in a thickness direction of the optical recording medium. Therefore, it is difficult to make the hologram device thin.

### BRIEF SUMMARY

The present invention is achieved for overcoming the aforementioned related problems, and provides a hologram device that is suitable for being made thin even when a lens having a small numerical aperture NA is used.

The present invention also provides a hologram device that can restrict crosstalk even if a pinhole is not used.

The present invention further provides a hologram device that can restrict entry of dust and that makes it possible for collision between an optical recording medium and a pickup to occur less frequently.

According to the present invention, there is provided a hologram device comprising a light-emitting unit applying reference light to an optical recording medium, a lens converting the reference light into parallel light, and a light-receiving device converting reproduction light into an electrical signal by receiving the reproduction light output from the optical recording medium irradiated with the reference light. When a light axis of the reproduction light output from the optical recording medium is a first light axis, and a light axis crossing the first light axis is a second light axis, the light-receiving device includes a reflecting mirror, a light-receiving member, and an actuator, the reflecting mirror causing the light axis of the reproduction light to be oriented from the first light axis to the second light axis by reflecting the reproduction light, the light-receiving member disposed on the second light axis and having a light-receiving surface disposed so as to be oriented perpendicular to the second light axis, the actuator changing an inclination angle of the reflecting mirror.

More specifically, it is desirable that the first light axis and the second light axis be perpendicular to each other.

In the present invention, since the light-receiving member is not provided by superposition in a thickness direction, but is provided in a widthwise direction orthogonal to the thickness direction, the hologram device can be made thin.

In the above, it is desirable that a diameter of the reproduction light become gradually smaller with increasing distance from the optical recording medium, and become gradually larger beyond a beam waist where the diameter is smallest; a reflection area of the reflecting mirror be equal to or slightly larger than an area at the beam waist; and the reflecting mirror be provided at or near a location of the beam waist.

In the above-described means, it is possible to select only a desired reproduction light without using a pinhole filter, to output the reproduction light towards the light-receiving member.

It is desirable that the reflecting mirror and the light-receiving member be accommodated in one housing.

In the above-described means, it is possible to prevent entry of dust into the housing.

In this case, the housing may have an opening window guiding towards the reflecting mirror the reproduction light output from the optical recording medium, and the opening window may be provided with a cover transmitting the light.

In the above-described means, it is possible to allow impinging of the reproduction light while preventing the entry of dust into the housing.

Accordingly, the present invention makes it is possible to direct reproduction light towards any recording position. In addition, it is possible to reproduce a hologram recorded by an angle multiplexing method. In addition, it is possible to select only reproduction light required at the light-receiving device from a plurality of reproduction lights, and to receive the light.

The present invention can provide a hologram device that can restrict crosstalk without using a pinhole filter.

Even if a lens having a small numerical aperture NA is used, the hologram device can be made thin.

In addition, since the light-receiving device is accommodated in one housing, and a transparent cover is mounted to the opening window upon which the reproduction light is incident, it is possible prevent the entry of dust into the housing.

### BRIEF DESCRIPTION OF THE DRAWINGS

FIG. 1 is an exploded perspective view of a pickup of a reference example of a hologram device, which is a basic structure according to the present invention;

FIG. 2 is a schematic view conceptually showing the structure of a light-receiving device; and

FIG. 3 is a conceptual diagram showing the relationship between reproduction light and reference light used with respect to an optical recording medium.

### DETAILED DESCRIPTION OF THE DRAWINGS AND THE PRESENTLY PREFERRED EMBODIMENTS

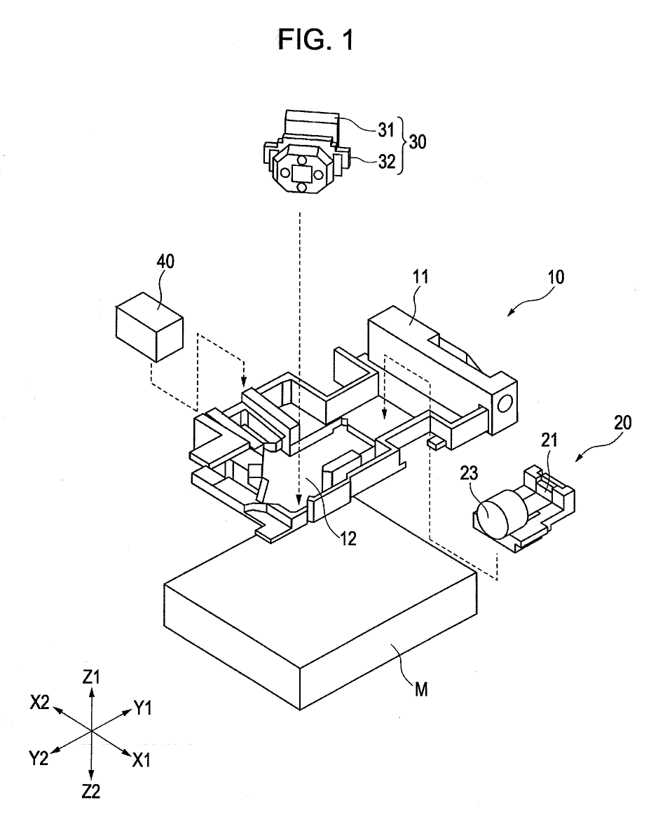

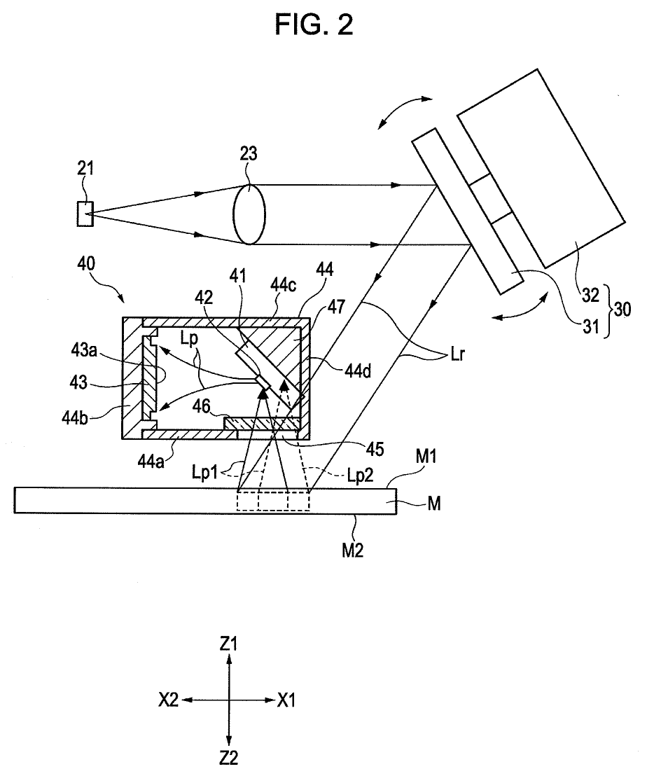

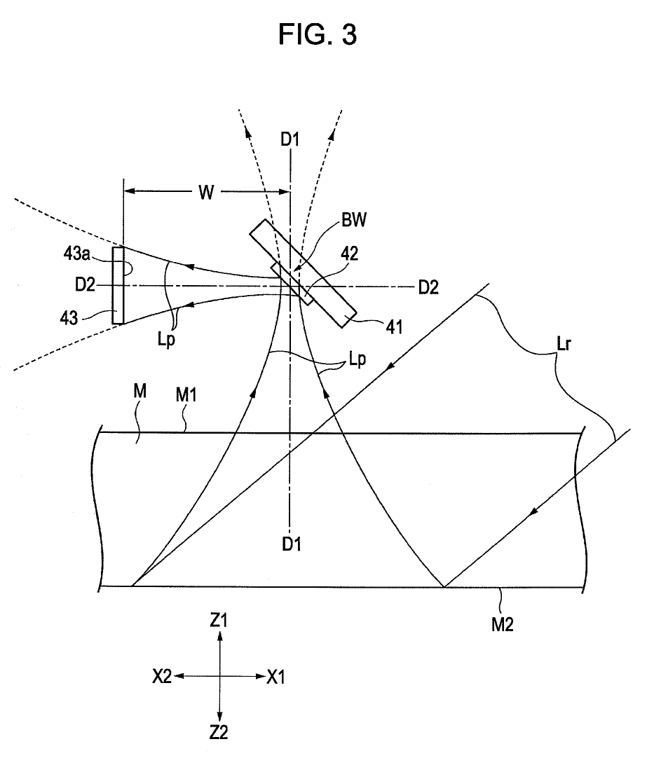

FIG. 1 is an exploded perspective view of a pickup of a reference example of a hologram device, which is a basic structure according to the present invention. FIG. 2 is a schematic view of the structure of a light-receiving device. FIG. 3 is a conceptual diagram showing the relationship between reproduction light and reference light used with respect to an optical recording medium.

As shown in FIG. 1, the hologram device comprises a pickup 10 that reads information (data) recorded on an optical recording medium.

An optical recording medium M that is described below is what is called a reflecting optical recording medium, and has a reflecting layer below a recording layer on which an interference pattern can be recorded. However, the optical recording medium M may be a transmitting optical recording medium that does not have a reflecting layer. As an interference pattern (a two-dimensional checkered dot pattern), a hologram that indicates a large number of items of data is recorded by multiplexing within the recording layer while a recording angle is changed.

The pickup 10 has a movable base 11 provided so as to be made movable in biaxial directions (that is, an X direction and a Y direction in FIG. 1) in a plane by a driving mechanism (not shown). The movable base 11 can be moved in the X direction and the Y direction while opposing the optical recording medium M.

A light-emitting device 20, which generates reference light, a mirror actuator 30, which changes a direction of the reference light to a predetermined direction, and a light-receiving device 40, which reads a hologram by receiving reproduction light output from the optical recording medium M are mounted to the movable base 11.

The light-emitting device 20 comprises, for example, a Vertical Cavity Surface Emitting Laser (VCSEL), and includes, for example, a light-emitting unit 21 and a collimating lens 23. The light-emitting unit 21 includes, for example, a light source that generates reference light and a beam expander that enlarges the reference light output from the light source. The collimating lens 23 converts the enlarged reference light into parallel light. The collimating lens 23 in the embodiment has a small numerical aperture NA. Therefore, at the collimating lens 23, spherical aberration is low. The light-emitting unit 21 and the collimating lens 23 are integrally mounted to each other. The reference light generated at the light-emitting device 20 is output towards the mirror actuator 30 that is described next.

The mirror actuator 30 comprises a mirror 31, which reflects the reference light incident thereupon, and a driving unit 32, which varies the inclination angle of the mirror 31 within a predetermined range. The driving unit 32 may comprise a related driving mechanism such as a magnetic driving mechanism or an electrostatic driving mechanism. The mirror 31 is swingably supported at the driving unit 32. Controlling the driving unit 32 makes it possible to freely adjust the inclination angle of the mirror 31.

As shown in FIG. 1, an opening 12 is provided in the movable base 11 so as to extend therethrough in an illustrated Z direction. The mirror actuator 30 is secured to edges of the opening 12. Reference light reflected by the mirror 31 is output towards the optical recording medium M, positioned at a lower (Z2) side of the movable base 11, through the opening 12.

The light-receiving device 40 is also provided near the opening 12. As shown in FIG. 2, the light-receiving device 40 comprises a reflecting mirror 42, secured to a central portion of a stage 41, and a light-receiving member 43. The reflecting mirror 42 and the light-receiving member 43 are accommodated in a housing 44.

The housing 44 is a box-like member whose dimension in a widthwise direction (in an X direction in FIG. 2) is greater than its dimension in a thickness direction (in a Z direction).

The housing 44 has an opening window 45. The opening window 45 is provided at one side in one of the widthwise directions (X1 direction in FIG. 2) at a lower surface 44a of the housing 44 opposing the optical recording medium M. A transparent cover 46 that transmits light therethrough is secured to the opening window 45. The housing 44 is in a closed state, so that dust is prevented from entering the housing 44.

The transparent cover 46 is secured in the housing 44, and does not protrude out of the housing 44. Therefore, it is possible to prevent the transparent cover 46 from colliding with the optical recording medium M.

The light-receiving member 43 comprises pickup means, such as a CMOS sensor or a CCD. The light-receiving member 43 is perpendicular to the lower surface 44a having the opening window 45, and is secured to a side surface 44b in another one of the widthwise directions (X2 direction in FIG. 2). That is, a light-receiving surface 43a of the light-receiving member 43 is secured to the side surface 44b while being oriented in the X1 direction, and is perpendicular to a surface M1 of the optical recording medium M.

The stage 41 is provided at a location opposing both of the light-receiving member 43 and the transparent cover 46 in the housing 44. More specifically, a triangular base 47 is provided at a corner in the housing 44 formed by a top surface 44c, opposing the lower surface 44a of the housing 44, and the side surface 44d, opposing the side surface 44b. The stage 41 is secured while being inclined on an inclined surface of the base 47.

The stage 41 is formed as a non-reflecting surface using, for example, a light-absorbing material (used to, for example, black-lacquer a surface of the stage 41) or a light-transmitting material transmitting light. The reflecting mirror 42 is secured to substantially the center of the stage 41.

When the reflecting mirror 42 is not provided, as shown by dotted lines in FIG. 3, reproduction light Lp, output from the optical recording medium M, has a characteristic in which optical phase conjugation causes its diameter to become gradually smaller in a Z1 direction with increasing distance from the optical recording medium M, and its diameter to become gradually larger beyond a beam waist BW where the diameter is smallest.

The reflecting mirror 42 is secured at or near the location of the beam waist BW so that its inclination angle is 45 degrees. The reflecting mirror 42 has a very small area. That is, the reflecting mirror 42 has an area that is equal to or slightly greater than that defined by the diameter at the beam waist BW. Regarding the size and shape of the reflecting mirror 42, its diameter is on the order of 250 μm and its shape is circular; or one side is on the order of 250 μm and its shape is rectangular. However, the size and shape are not limited thereto.

Here, as shown in FIG. 3, an imaginary line passing through the center of the beam waist BW and extending perpendicularly to the optical recording medium M is expressed as a first light axis D1. Similarly, an imaginary line passing through an intersection of the first light axis D1 and the reflecting mirror 42 and crossing the first light axis D1 perpendicularly thereto (extending parallel to the optical recording medium M) is expressed as a second light axis D2. The light-receiving member 43 is secured to the side surface 44b of the housing 44 on the second light axis D2 while the light-receiving surface 43a is oriented perpendicularly to the second light axis D2.

In this way, in the reference example, the light-receiving member 43 is provided not at a location where it is perpendicular to the first light axis D1, but at a location where it is perpendicular to a surface of the optical recording medium M (that is, the second light axis D2). Therefore, a light path length W between the beam waist BW and the light-receiving member 43 may be defined in a direction parallel to the optical recording medium M instead of in the thickness direction of the optical recording medium M. Therefore, it is possible to prevent the pickup 10 from becoming thick in the thickness direction (Z direction).

In particular, since the reproduction light Lp, output from the optical recording medium M, is gradually enlarged beyond the beam waist BW, it is effective to increase the light path length W to the extent possible for increasing a light-reception area of the light-receiving member 43 to its limit. However, when, as described above, the collimating lens 23 having the small numerical aperture NA is used, the focal length thereof is longer than that of a lens having a large numerical aperture NA. Therefore, for making the light path length W long in the related art, the pickup 100 needs to be made thick.

However, in the reference example, as discussed above, the light path length W is defined, not in the thickness direction (Z direction), but in the widthwise direction (X direction) perpendicular to the thickness direction, so that it is possible to more effectively prevent the thickness-direction dimension of the pickup 10 from increasing.

Since the lens having the small numerical aperture NA is used, the distance from the optical recording medium M to the beam waist BW is also increased. Therefore, the distance between the optical recording medium M and the lower surface 44a of the housing 44 needs to be set longer than that in the related art. Consequently, the position of the housing 44 of the pickup 10 is disposed further away from the optical recording medium M than that in the related art. The distance in this case is approximately 200 μm, which is sufficiently larger than the distance (on the order of 100 μm) when a related lens having a large numerical aperture NA is used. Therefore, collision of the pickup 10, in particular, the lower surface 44a of the housing 44, with the optical recording medium M occurs less frequently. The distance (200 μm) is very small compared to the size of the entire hologram device, so that its influence on the height of the entire device is substantially negligible.

The hologram device will hereunder be described.

When the movable base 11 is moved in the biaxial directions (X and Y directions) in the plane, the transparent cover 46 moves while opposing the surface of the optical recording medium M.

Next, the movable base 11 is stopped at any recording position (book), and reference light Lr is output from the light-emitting device 20 towards the mirror actuator 30. The reference light Lr is reflected by the mirror 31 of the mirror actuator 30, and illuminates the optical recording medium M.

At this time, the angle of the mirror actuator 30 is adjusted so that the reference light Lr reflected by the mirror 31 can illuminate any recording position (book) on the optical recording medium M at a predetermined angle.

The reference light Lr with which the optical recording medium M is irradiated is transmitted through the optical recording medium M, is reflected again at a reflecting layer M2, provided at a bottom side of the optical recording medium, and is output as the reproduction light Lp to the outside of the optical recording medium M.

The reproduction light Lp is incident upon the interior of the light-receiving device 40, is bent by 90 degrees by the reflecting mirror 42, and is received by the light-receiving member 43. The reproduction light Lp has the beam waist BW at the position of the reflecting mirror 42, and is gradually enlarged beyond the reflecting mirror 42. However, since the light path between the reflecting mirror 42 and the light-receiving member 43 extends in the widthwise (X) direction, the light path length W is sufficiently provided. Therefore, the light-receiving member 43 can receive the reproduction light Lp in a sufficiently enlarged state.

The transparent cover 46 is provided midway between the optical recording medium M and the beam waist BW. Therefore, a portion of the reproduction light Lp having a diameter that is larger than that at the beam waist BW passes through the transparent cover 46. Consequently, the influence of the transparent cover 46 on aberrations of the reproduction light Lp can be reduced.

Not only may any recording position (book) on the optical recording medium M be irradiated with the reference light Lr, but also a plurality of recording positions (books) adjacent to the any recording position may be irradiated with the reference light Lr at the same time. For example, as shown in FIG. 2, a predetermined reproduction light Lp1 from the any recording position (book) and another predetermined reproduction light Lp2 from another recording position (book) adjacent thereto may be output at the same time. When the light-receiving member 43 receives two or more reproduction lights Lp at the same time, what is called cross talk occurs.

However, since the reflecting mirror 42 has a very small area, the reflecting mirror 42 only reflects either one of the incident reproduction lights Lp1 and Lp2. Therefore, the reproduction light that is reflected by the reflecting mirror 42 is limited to either one of the reproduction lights Lp, that is, the predetermined reproduction light (the reproduction light Lp1 in FIG. 2) from the any recording position (book), thereby restricting crosstalk.

Here, the other reproduction light Lp2 illuminates the vicinity of the reflecting mirror 42, that is, the stage 41. The stage 41 is formed as a non-reflecting surface (using light-absorbing material or light-transmitting material) as mentioned above. Therefore, the other reproduction light Lp2 is either absorbed by or is transmitted through the stage 41, so that it is not received by the light-receiving member 43. That is, the light-receiving member 43 only receives the predetermined reproduction light Lp1 from the any recording position (book), and the unnecessary reproduction light Lp2 can be intercepted by the non-reflecting surface of the stage 41. Consequently, since the reflecting mirror 42 having a very small area and the non-reflecting surface of the stage 41 function as a pinhole filter, it is possible to restrict the occurrence of what is called crosstalk without using a pinhole filter.

Although, in the reference example, the reflecting mirror 42 is secured to the stage 41 having the non-reflecting surface, the present invention is not limited thereto. That is, it is possible to form the stage using a light-receiving element that can receive a plurality of reproduction lights Lp all at once, to provide the reflecting mirror 42 at the center thereof, and to form the base 47 using an actuator. In this case, the mirror actuator 30 is not required.

Accordingly, the light-receiving element can receive a plurality of reproduction lights Lp all at once. In addition, on the basis of the plurality of reproduction lights Lp, the reproduction light Lp to be reflected by the reflecting mirror 42 is extracted at a computing section (not shown), and information thereof is output as a feedback signal. Then, on the basis of the feedback signal, the actuator that drives the light-receiving element and the reflecting mirror 42 is driven as appropriate, so that only the predetermined reproduction light Lp to be output among the plurality of reproduction lights Lp towards the light-receiving member 43 can be reflected by the reflecting mirror 42 towards the light-receiving member 43. Therefore, even in this case, what is called crosstalk can be restricted.

Although, in the embodiment, the reflecting mirror 42 is secured to the inclined surface of the base 47 so as to be set at an angle of 45 degrees, and the second light axis D2 crosses the first light axis D1 perpendicularly thereto, the present invention is not limited thereto. That is, the first light axis D1 need not cross the second light axis D2 perpendicularly thereto, so that it may cross the second light axis D2 at other angles. However, when, as described above, the first light axis D1 crosses the second light axis D2 perpendicularly thereto, the second light axis D2 can be made parallel to the surface M1 of the optical recording medium M. Therefore, this is desirable from the viewpoint of making the hologram device thin.

1. A hologram device comprising:
a light-emitting unit applying reference light to an optical recording medium;
a lens converting the reference light into parallel light; and
a light-receiving device converting reproduction light into an electrical signal by receiving the reproduction light output from the optical recording medium irradiated with the reference light,
wherein when a light axis of the reproduction light output from the optical recording medium is a first light axis, and a light axis crossing the first light axis is a second light axis,
the light-receiving device includes a reflecting mirror, a light-receiving member, and an actuator, the reflecting mirror causing the light axis of the reproduction light to be oriented in a direction of the second light axis by reflecting the reproduction light, the light-receiving member disposed on the second light axis and having a light-receiving surface disposed so as to be oriented perpendicular to the second light axis, the actuator changing an inclination angle of the reflecting mirror.

2. The hologram device according to claim 1, further comprising a light-receiving element disposed at a location where the light-receiving element is capable of receiving the reproduction light, an inclination angle of the light-receiving element and the inclination angle of the reflecting mirror being changed by the actuator,
wherein the actuator is driven on the basis of a light-reception signal of the light-emitting element.

3. The hologram device according to claim 2, wherein the light-receiving element is provided at a stage driven by the actuator, and the reflecting mirror is provided at the center of the light-receiving element.

4. The hologram device according to claim 1, wherein the first light axis and the second light axis are perpendicular to each other.

5. The hologram device according to claim 1, wherein a diameter of the reproduction light becomes gradually smaller with increasing distance from the optical recording medium, and becomes gradually larger beyond a beam waist where the diameter is smallest, and
wherein a reflection area of the reflecting mirror is equal to or slightly larger than an area at the beam waist.

6. The hologram device according to claim 1, wherein a diameter of the reproduction light becomes gradually smaller with increasing distance from the optical recording medium, and becomes gradually larger beyond a beam waist where the diameter is smallest, and
wherein the reflecting mirror is provided at or near a location of the beam waist.

7. The hologram device according to claim 1, wherein the reflecting mirror and the light-receiving member are accommodated in a housing.

8. The hologram device according to claim 7, wherein the housing has an opening window guiding towards the reflecting mirror the reproduction light output from the optical recording medium, and wherein the opening window is provided with a cover transmitting light.
